(19) United States
(12) Patent Application Publication
(10) Pub. No.: US 2014/0156730 A1
(43) Pub. Date: Jun. 5, 2014

(54) SYNCHRONIZATION SYSTEM AND METHOD THEREOF

(71) Applicants: INVENTEC (PUDONG) TECHNOLOGY CORPORATION, Shanghai (CN); INVENTEC CORPORATION, Taipei (TW)

(72) Inventor: Sean LIU, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/803,247

(22) Filed: Mar. 14, 2013

(30) Foreign Application Priority Data
Nov. 30, 2012 (CN) 201210507480.1

(51) Int. Cl. H04L 29/06

(52) U.S. Cl. CPC H04L 67/42
USPC 709/203

(57) ABSTRACT

A synchronization system and a method thereof are provided. A synchronization server detects a location message of a client to generate a time zone label, calculates a use frequency according to a use time of the client, and according to the use frequency and the number of clients with the same time zone label and synchronization time, sets a practical synchronization time for each client, so as to distribute the time point of synchronization processing on each client and the synchronization server, thereby achieving the technical efficacy of improving load balancing of the synchronization processing.

### BACKGROUND OF THE INVENTION

1. Field of the Invention

The present invention relates to a synchronization system and a method thereof, and more particularly to a synchronization system and a method thereof for distributing, according to a use frequency and a location message of a client, the time point of synchronization processing on each client and a synchronization processing end.

2. Description of Related Art

In recent years, with the widespread and vigorous development of cloud technologies, the number of cloud service users increases year by year, which easily causes an overload problem at a server for synchronization processing in a cloud service.

Generally, in a conventional synchronization processing technology, when a client is connected to a server, synchronization processing of data is performed immediately or a user sets the time of synchronization processing. However, in this mode, all clients might require synchronization processing with a server at close time points, which overloads the server to cause undesirable efficiency of synchronization processing or even failures on the server. Therefore, the problem of undesirable load balancing is present in the conventional synchronization processing.

In view of the problem, a manufacturer has proposed a method for allocating a sequence of scheduling processing for clients according to an upper threshold of synchronization processing and weight values of the clients. In this manner, it can be ensured that synchronization processing is first performed on a client with a high weight value and the number of clients that undergo synchronization processing simultaneously is limited to prevent the server from being overloaded. However, in the foregoing mode, it might be impossible to successfully perform synchronization processing on a client with a low weight value, and also, the case in which synchronization processing is performed on a great number of clients in close time points is not avoided. Therefore, the foregoing mode still fails to effectively solve the problem of undesirable load balancing.

To sum up, it can be known that for a long time the prior art has the problem of undesirable load balancing in synchronization processing, and therefore, it is really necessary to propose an improved technical means to solve this problem.

### SUMMARY OF THE INVENTION

In view of the problem in the prior art, the present invention discloses a synchronization system and a method thereof.

The synchronization system disclosed in the present invention includes a client and a synchronization server. The client is configured for transmitting a connection message. The synchronization server includes a storage module, a detection module, a calculation module, an adjustment module, and a synchronization module. The storage module is configured for storing a used record and a synchronization time of each client; the detection module is configured for receiving the connection message and detecting the location message and the use time of the client according to the connection message, then generating a time zone label according to the location message, and recording the time zone label and the use time to the used record corresponding to the client; the calculation module is configured for calculating a use frequency of each client through the use time according to the used record of each client, and calculating the number of clients with the same time zone label and same synchronization time; the adjustment module is configured for adjusting and setting a practical synchronization time of each client according to the use frequency and the number of clients; and the synchronization module is configured for perform synchronization processing on the synchronization server and the clients according to the practical synchronization time.

A synchronization method according to the present invention is provided. The steps of the method comprise: storing a used record and a synchronization time of a client; detecting a location message and a use time of the client according to connection message after the connection message is received from the client, then generating a time zone label according to the location message, and recording the time zone label and the use time to the used record corresponding to the client; calculating a use frequency of each client through the use time according to the used record of each client, and calculating the number of clients with the same time zone label and same synchronization time; adjusting and setting a practical synchronization time of each client according to the use frequency and the number of clients; and performing synchronization processing on the synchronization server and the client according to the practical synchronization time.

The system and the method disclosed in the present invention are described as above, and the difference between the present invention and the prior art lies in that in the present invention, a synchronization server detects the location message of a client to generate a time zone label, calculates a use frequency according to the use time of the client, and sets, according to the use frequency and the number of clients with the same time zone label and synchronization time, a practical synchronization time of each client, so as to distribute the time point of synchronization processing on each client and the synchronization server.

Through the foregoing technical means, the present invention may achieve the technical efficacy of improving load balancing of synchronization processing.

### BRIEF DESCRIPTION OF THE DRAWINGS

The invention will become more fully understood from the detailed description given herein below illustration only, and thus is not limitative of the present invention, and wherein:

FIG. 1 is a system block diagram of a synchronization system according to the present invention.

FIG. 2 is a method flow chart of a synchronization method according to the present invention.

FIG. 3 is a first schematic view of client data stored at a synchronization server according to the present invention.

FIG. 4 is a second schematic view of client data stored at a synchronization server according to the present invention.

### DETAILED DESCRIPTION OF THE EMBODIMENTS

The present invention will be apparent from the following detailed description, which proceeds with reference to the accompanying drawings, wherein the same references relate to the same elements.

Before the synchronization system and method thereof disclosed in the present invention are illustrated, terms defined in the present invention are illustrated first. A used record described in the present invention is used for recording the location and a use time of a client detected by a synchronization server, so that the synchronization server subsequently calculates a use frequency of the client according to these records, so as to prevent that a great number of clients having the same location and synchronization time require synchronization processing with the synchronization server.

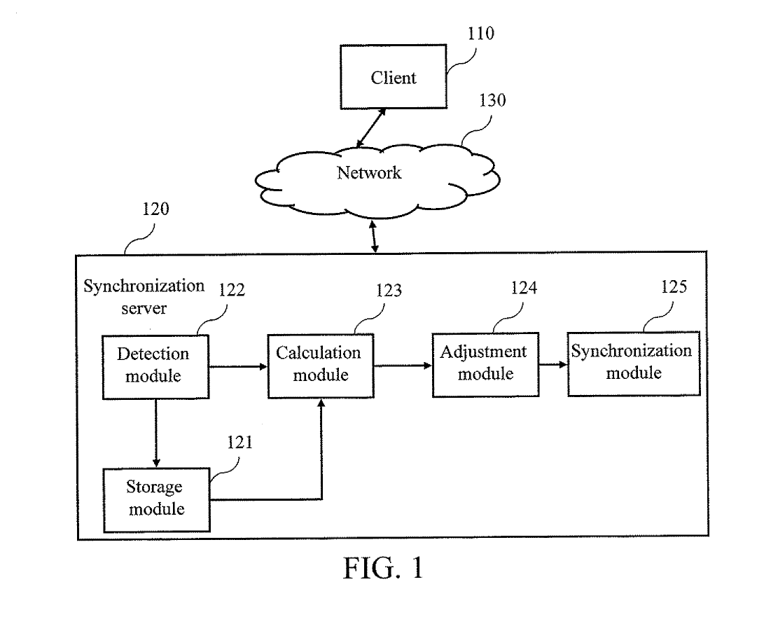

The synchronization system and method thereof according to the present invention are further illustrated below with reference to accompanying drawings. Referring to FIG. 1, FIG. 1 is a system block diagram of the synchronization system according to the present invention. The system includes a client 110 and a synchronization server 120. The client 110 is configured for transmitting a connection message, where the connection message is a packet message of logging in to the synchronization server 120, and the client 110 and the synchronization server 120 transmit the connection message and perform data transmission and synchronization through a network 130. In a practical implementation, the client 110 is a computer device with a network transmission function, such as a personal computer, a Personal Digital Assistant (PDA), and a mobile phone.

For the synchronization server 120, the synchronization server 120 includes a storage module 121, a detection module 122, a calculation module 123, an adjustment module 124, and a synchronization module 125. The storage module 121 is configured for storing a used record and a synchronization time of each client 110, where the synchronization time is a time set by a user to perform synchronization processing, and the synchronization time may be prestored by the user in the storage module 121. In a practical implementation, the storage module 121 may further store a priority level of each client 110 (for example, the priority level of a paid member is “high”, the priority level of an ordinary member is “intermediate”, and the priority level of a visitor is “low”), and provides the priority level to the adjustment module 124, so that the adjustment module 124 sets a practical synchronization time of each client 110 according a use frequency, the number of clients, and the priority level.

The detection module 122 is configured for receiving the connection message from the client 110 and detecting a location message and the use time (for example, the time that the client 110 logs in to the synchronization server 120) of the client 110 according to the connection message. The location message indicates a practical location message of the client 110, for example, Shanghai, Taipei, and the United States, which can be determined by detecting the IP address of the client 110; the judgment mode is a conventional technology, so the details are not described here. Then, the detection module 122 generates a time zone label according to the location message. For example, when it is assumed that the location message is “Taipei”, the time zone corresponding to “Taipei” is found according to a time zone mapping table, for example, “GMT+8”, and the found time zone “GMT+8” is used as a time zone label, and the time zone label and the use time are recorded in the used record of the corresponding client 110 in the storage module 121. It should be especially noted that although an offset (for example, “GMT+8”) of the Greenwich Mean Time is used as a time zone in the foregoing description, the present invention is not limited thereto. In practical implementation, any manner indicating a time zone does not depart from the application scope of the present invention.

The calculation module 123 is configured for calculating a use frequency of each client 110 by using the use time in the used record according to the used record of each client 110. For example, when it is assumed that the use time in the used record is “2012/10/25; 2012/10/26; 2012/10/27”, the calculation module 123 can calculate the number of use times (for example, the value “3”) according to a preset time interval (for example, 2012/10/25 to 2012/10/27); or when it is assumed that the use time is a recorded period of time between the login of the client 110 to the synchronization server 120 and the logout from the synchronization server 120 (for example, 2012/10/25 12:11:20; 2012/10/25 13:11:20), the calculation module 123 can further calculate an accumulated total number of hours (for example, the value “1”) within the time interval. In this manner, the calculation module 123 can calculate the use frequency of the client 110 according to the number of use times or the total number of hours, where the number of use times or the number of total hours is positively correlated with the use frequency. Then, the calculation module 123 calculates the number of clients with the same time zone label and same synchronization time. For example, when it is assumed that 12 clients 110 have the time zone label “GMT+8” and the synchronization time “2012/10/25 12:00:00”, the calculation module 123 calculates the number of clients as “12”.

The adjustment module 124 is configured for adjusting and setting a practical synchronization time of each client 110 according to the use frequency and the number of clients calculated by the calculation module 123. For the foregoing example, when it is assumed that the number of clients “12” is the maximum value, the adjustment module 124 readjusts and resets the synchronization time of each of the 12 clients 110 whose synchronization time is “2012/10/25 12:00:00” as the practical synchronization time. The adjustment mode is that a priority sequence of synchronization processing is adjusted according to the use frequency of each client 110. For example, when it is assumed that the average number of clients is 6, the practical synchronization time of 6 clients 110 with high use frequencies is set to “2012/10/25 12:00:00” (that is, the synchronization time keeps unchanged) and the synchronization time of the other 6 clients 110 is also set according to the use frequencies, for example, it is set that the synchronization processing is performed an hour later (that is, “2012/10/25 13:00:00”). It should be especially noted that any mode does not depart from the application scope of the present invention as long as the practical synchronization time of each client 110 is adjusted and set according to the use frequency of the client 110 and the number of clients with the same time zone and synchronization time.

The synchronization module 125 is configured for performing synchronization processing on the synchronization server 120 and the client 110 according to the practical synchronization time adjusted and set by the adjustment module 124. Since the mode of the synchronization processing is a conventional technology, the details are not described here.

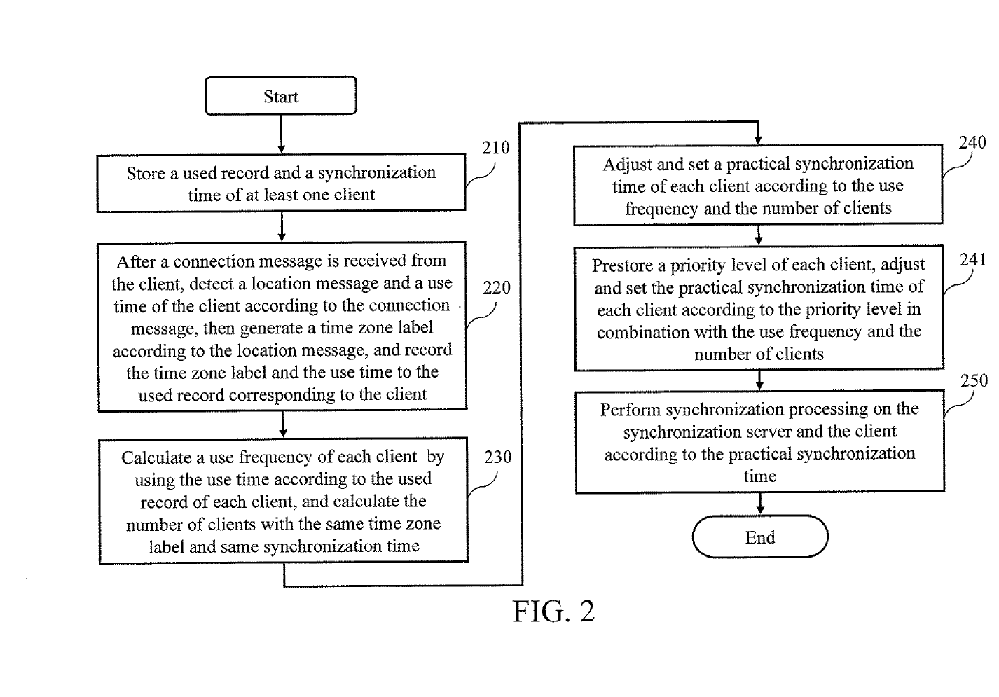

Then, referring to FIG. 2, FIG. 2 is a method flow chart of the synchronization balancing method according to the present invention. Steps of the method comprise: storing a used record and a synchronization time of a client 110 (Step 210); after a connection message is received from the client 110, detecting a location message and a use time of the client 110, generating a time zone label according to the location message, and recording the time zone label and the use time in the used record corresponding to the client 110 (Step 220); calculating, according to the used record of each client 110, by using the use time, a use frequency of each client 110, and calculating the number of client with the same time zone label and synchronization time (Step 230); adjusting and setting a practical synchronization time of each client 110 according to the use frequency and the number of clients (Step 240); and performing synchronization processing on the synchronization server 120 and the client 110 according to the practical synchronization time (Step 250). Through the foregoing steps, the synchronization server 120 detects the location message of the client 110 to generate a time zone label, calculates a use frequency according to the use time of the client 110, and sets a practical synchronization time of each client 110 according to the use frequency and the number of clients with the same time zone label and synchronization time, so as to distribute the time point of synchronization processing on each client 110 and the synchronization server 120.

In addition, after Step 240, according to a prestored priority level of each client 110, the practical synchronization time of each client may be further adjusted and set according to the priority level in combination with the use frequency and the number of clients (Step 241). In other words, apart from the adjustment according to the use frequency and the number of clients, the priority level of the client 110 may also affect the practical synchronization time of the client 110 set eventually.

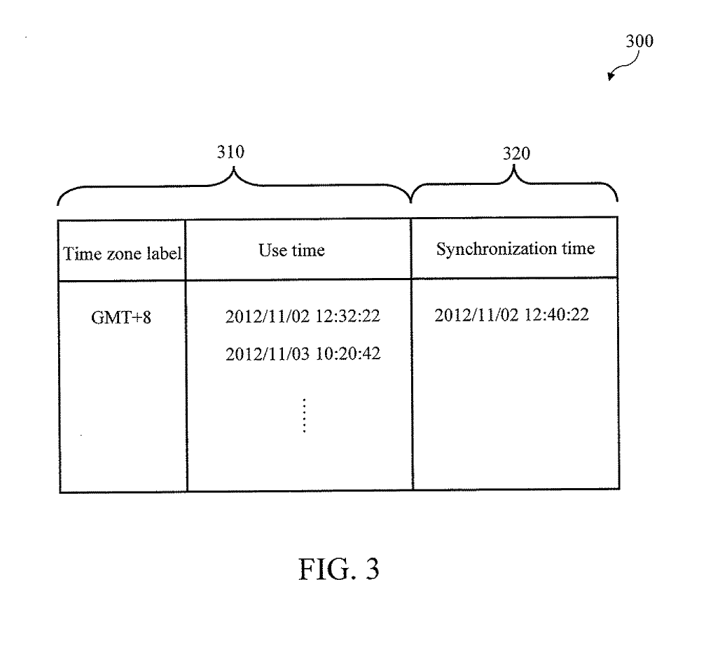

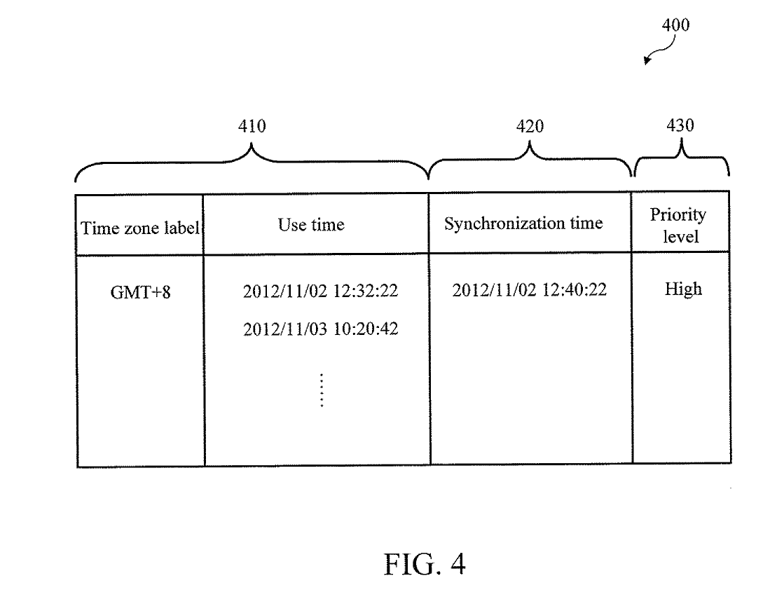

The description is made through an embodiment with reference to FIGS. 3 and 4. Referring to FIG. 3, FIG. 3 is a first schematic view of client data stored at the synchronization server according to the present invention. As mentioned above, the storage module 121 of the synchronization server 120 stores a used record and a synchronization time of each client 110. In a practical implementation, the storage mode may be implemented by a data table 300, and each client 110 corresponds to each data table. The detection module 122 records the time zone label and the use time in the used record 310, and stores the time zone label and the use time, together with the synchronization time 320, in the data table 300 corresponding to the client 110. In this manner, the calculation module 123 can read the use time in the used record 310 according to the data table 300 to calculate the use frequency of each client 110, calculate the number of clients with the same condition according to the synchronization time 320 and the time zone label in the used record 310, and provide the adjustment module 124 with the use frequency and the number of clients to adjust and set the practical synchronization time of each client 110, so that the synchronization module 125 is capable of performing synchronization processing on the synchronization server 120 and the client 110 according to the practical synchronization time. In a practical implementation, if all the clients 110 are recorded in the same data table, an identification field (not shown) must be added to differentiate each client 110.

Referring to FIG. 4, FIG. 4 is a second schematic view of client data stored at the synchronization server according to the present invention. As mentioned above, the storage module 121 may further prestore a priority level of each client 110. Likewise, in a practical implementation, the priority level may also be stored in a data table corresponding to the client 110 to form a data table 400 with a priority level, and the data table 400 with the priority level includes a used record 410, a synchronization time 420, and a priority level 430. The used record 410 includes the time zone label and the use time. Through the data table 400 with the priority level, the adjustment module 124 is capable of setting the practical synchronization time of each client 110 according to the use frequency and the number of clients calculated by the calculation module 123 together with the priority level 430. It should be especially noted that the practical synchronization time set by the adjustment module 124 is to replace the time originally recorded in the synchronization time 420.

To sum up, it can be known that the difference between the present invention and the prior art lies in that the synchronization server detects the location message of a client to generate a time zone label, calculates a use frequency according to the use time of the client, and sets a practical synchronization time of each client according to the use frequency and the number of clients with the same time zone label and synchronization time, thereby distributing the time point of synchronization processing on each client and the synchronization server. This technical means may solve the problem existing in the prior art, so as to achieve the technical efficacy of improving load balancing of synchronization processing.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A synchronization system, comprising:
at least one client, configured for transmitting a connection message; and
a synchronization server, comprising:
a storage module, configured for storing a used record and a synchronization time of each client;
a detection module, configured for receiving the connection message and detecting a location message and a use time of the client according to the connection message, then generating a time zone label according to the location message, and recording the time zone label and the use time to the used record corresponding to the client;
a calculation module, configured for calculating a use frequency of each client by using the use time according to the used record of each client, and calculating the number of clients with the same time zone label and same synchronization time;
an adjustment module, configured for adjusting and setting a practical synchronization time of each client according to the use frequency and the number of clients; and
a synchronization module, configured for performing synchronization processing on the synchronization server and the client according to the practical synchronization time.

2. The synchronization system according to claim 1, wherein the storage module further comprises a prestored priority level of each client, and the adjustment module sets the practical synchronization time of each client according to the use frequency, the number of clients, and the priority level.

3. The synchronization system according to claim 1, wherein the time zone label is an offset of the Greenwich Mean Time obtained by searching a time zone mapping table according to the location of the client.

4. The synchronization system according to claim 1, wherein the use frequency is the total number of hours of the use time within a preset time interval calculated according to the time interval, and the total number of hours is positively correlated with the use frequency.

5. The synchronization system according to claim 1, wherein the practical synchronization time is recorded in the used record corresponding to the client and replaces the synchronization time.

6. A synchronization method, applied in a synchronization server, wherein the steps of the method comprise:
storing a used record and a synchronization time of at least one client;
detecting a location message and a use time of the client according to a connection message after the connection message is received from the client, then generating a time zone label according to the location message, and recording the time zone label and the use time to the used record corresponding to the client;
calculating a use frequency of each client by using the use time according to the used record of each client, and calculating the number of clients with the same time zone label and same synchronization time;
adjusting and setting a practical synchronization time of each client according to the use frequency and the number of clients; and
performing synchronization processing on the synchronization server and the client according to the practical synchronization time.

7. The synchronization method according to claim 6, further comprising a step of prestoring a priority level of each client, so as to adjust and set the practical synchronization time of each client according to the priority level in combination with the use frequency and the number of clients.

8. The synchronization method according to claim 6, wherein the time zone label is an offset of the Greenwich Mean Time obtained by looking up a time zone mapping table according to the location of the client.

9. The synchronization method according to claim 6, wherein the use frequency is the total number of hours of the use time within a preset time interval calculated according to the time interval, and the total number of hours is positively correlated with the use frequency.

10. The synchronization method according to claim 6, wherein the practical synchronization time is recorded in the used record corresponding to the client and replaces the synchronization time.
